(19) United States
(12) Patent Application Publication
(10) Pub. No.: US 2009/0034422 A1
(43) Pub. Date: Feb. 5, 2009

(54) ATM Protection System

(76) Inventor: Francesco Pasio, Genova (IT)

Correspondence Address: COATS & BENNETT, PLLC, 1400 Crescent Green, Suite 300, Cary, NC, 27518, US

(21) Appl. No.: 11/722,622

(22) PCT Filed: Dec. 21, 2005
(86) PCT No.: PCT/EP05/57051

§ 371 Date: Jun. 22, 2007

(30) Foreign Application Priority Data
Dec. 23, 2004 (IT) MI2004A 002490

(51) Int. Cl. H04L 12/26

(52) U.S. Cl. 370/244

(57) ABSTRACT

A protection system for an ATM network (30) having a primary node (11,21) and a secondary node (12,13,14, 22) interconnected through an ATM transport capable network (30) of any topology. For each ATM (VPC/VCC) connection between the primary (11,21) and the secondary node (12, 13,14,22) this interconnecting network (30) makes available two independent paths (16, 17) that form independent working and protection paths. The primary node (11,21) sends traffic cells over both working path (16 or 17) and protection path (17 or 16) and receives and merges the traffic cells from both the paths (16 and 17). The secondary node (12, 22) transmits and receives traffic cells either on the bi-directional working path (16 or 17) or on the bi-directional protection paths (17 or 16) and the continuity of the working and protection path is monitored through the creation of appropriate ATM test circuits, named Test Trails (19, 20), between the primary node (11,21) and the secondary node (12,13,14,22). If the secondary node (12,13,14,22) detects discontinuity of the Test Trail (19 or 20) for the path (16 or 17) in use to carry the local traffic cells, then the local traffic cells (15) at the secondary node (12, 13,14,22) are switched onto the appropriate protection path (17 or 16) while no switching function is performed on the primary node (11). The generation of ATM-AIS (forward alarm signal) is inhibited in the primary node (11,21) and in the interconnecting network (30), whereas the generation of ATM-RDI (return alarm signal) is inhibited in the secondary node (12,13,14,22).

This invention relates to a protection system in Asynchronous Transfer Mode (ATM) networks. ATM-level protection systems are defined in international standards such as the ITU-T recommendation 1.630/G.808.1 and the PNNI systems defined by the ATM Forum.

In many cases, for example, in nodes for access networks with low capacity and cost, the implementation of such protection systems in ATM nodes can be too complicated and costly from the computational, and hence financial viewpoint. For example, in a ring network, there are three types of SNC/T I.630/G.808.1 standard protection systems that could be usable.

The first is a one-way “1+1” system. At each end point of the protection the traffic is transmitted on both the working path and the protection path and each end point chooses independently from which protection or working path to receive the traffic, with no need of using an Automatic Protection Switching (APS) protocol.

Another protection system is a two-way “1+1” system, in which, at each end point the traffic is transmitted both on the working path and on the protection path, and the APS protocol keeps the two end points aligned around the working or protection path in use at the time, in order to receive the traffic (that is both the end points receive either from the protection path or from the working path).

The third protection system is two-way “1:1” system, in which, at each end point the traffic is transmitted and received only by one path (protection or working) and the APS protocol keeps the two end points aligned so that the path selected is the same for both end points.

In low capacity and low cost access-networks nodes, such prior known systems cannot always be used. For example, it may be that the access equipment cannot support point-to-multipoint interconnections as required by the first two systems, or cannot support the APS protocol as required by the second and third systems.

US 2002/159392 (ADC Telecommunications) discloses a protection system for an ATM network. This reference uses the forward alarm signal (AIS) and the remote defect indication signal (RDI) to trigger switches. All of the nodes of the ring generate such alarms when they detect a failure.

In the present invention the forward alarm signal (AIS) is inhibited in the primary node and in the interconnecting network and the return alarm signal (RDI) is inhibited in the secondary node.

U.S. Pat. No. 6,259,837 (Nortel Networks Ltd) discloses a protection a system for protecting the connection between two SDH network rings. This reference is not concerned with connections between a primary node and secondary nodes of an ATM network (see, the paragraph entitled “Background of the invention” in U.S. Pat. No. 6,259,837). Similarly, European Patent 1,209,834 (Toshiba) refers to the International Standards ITU T/G.841 and ITUT/G.842 that apply to SDH/SONET systems. In this respect, one must not mix the ATM terminology used for the two end nodes of the protection paths, for example. ATM primary nodes and secondary nodes, with the terminology used for the nodes of an SDH system. ATM primary nodes and secondary nodes act very differently to the nodes of an SDH/SONET network.

For example, none of the nodes of a SDH network uses the concept of merging the received working and protection signals, whereas in an ATM network, the primary nodes merge the traffic from the working paths and the protection paths. In other words merging is applicable to ATM or packet transport but not to the SDH/SONET networks and the way that protection switching is achieved is very different.

An object of the present invention is to make available an innovative ATM solution capable of ensuring protection characteristics with low expenditure of resources and innovative characteristics.

In particular, the solution in accordance with the present invention also allows innovative performance compared to those obtainable with equipment using standard I.630/G.808.1 or PNNI protection mechanisms, together with scalability in some configurations (for example, constant exchange time independently of the number of equipments in the ring). This is achieved through low cost embodiments while keeping the software implementation simple and reliable.

According to one aspect of the present invention there is provided a protection system in an ATM network having a primary node and a secondary node interconnected through an ATM network and with working and protection paths between them and in which the primary node (PN) sends traffic cells over both paths and receives and performs merging of the traffic cells from both the paths, the continuity of the working and protection paths is monitored through creation of appropriate ATM test circuits, named Test Trails, between the primary node and the secondary node (SN) and if the secondary node detects a discontinuity of the Test Trail for the path in use the local traffic cells at the secondary node are switched towards the protection path while no switching function is performed on the primary node.

This invention also relates to an ATM system with said protection system. Further aspects of the present invention are set out in the attached claims.

To clarify the explanation of the innovative principles of this invention and its advantages compared with the prior art there is described below with the aid of the annexed drawings a possible embodiment thereof by way of non-limiting example applying said principles. In the drawings:

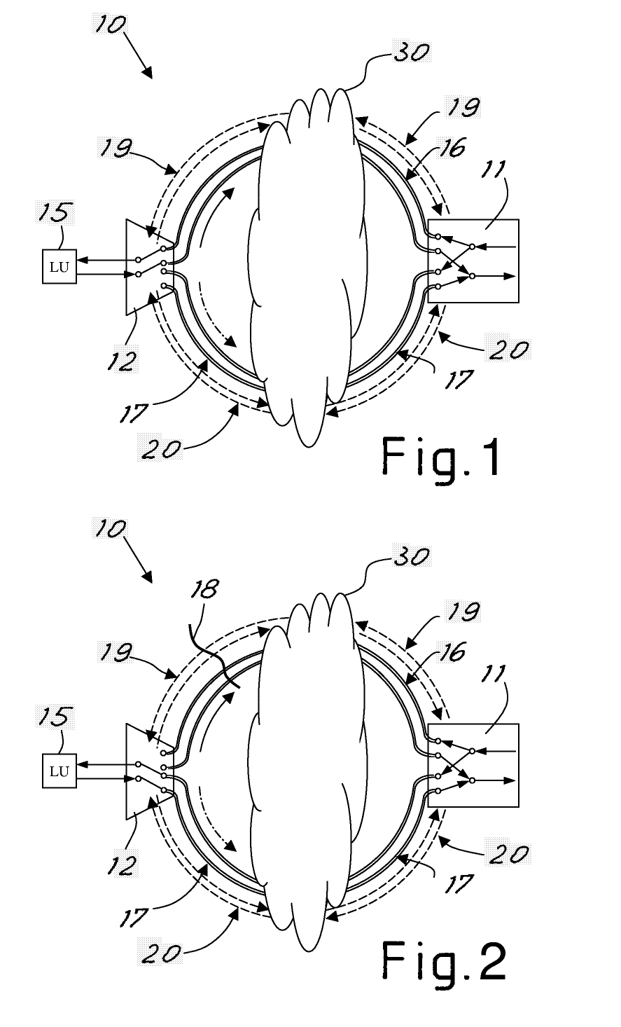

FIGS. 1 and 2 show a protection system in accordance with this invention in normal operating configuration and in a traffic reactivation mode after a failure,

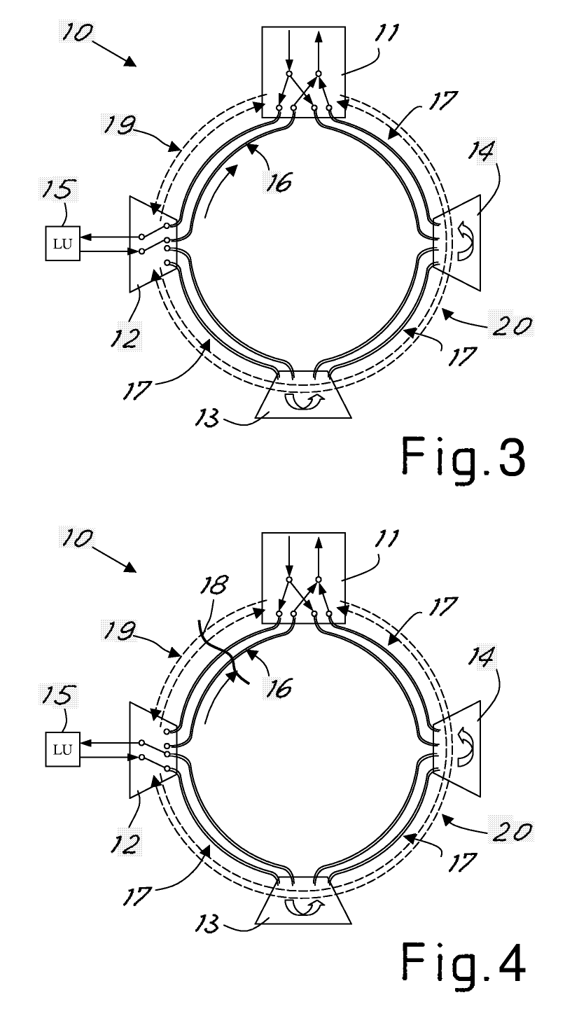

FIGS. 3 and 4 show diagrammatically a protection system in accordance with this invention similar to that of FIGS. 1 and 2, but applied to a ring network, and

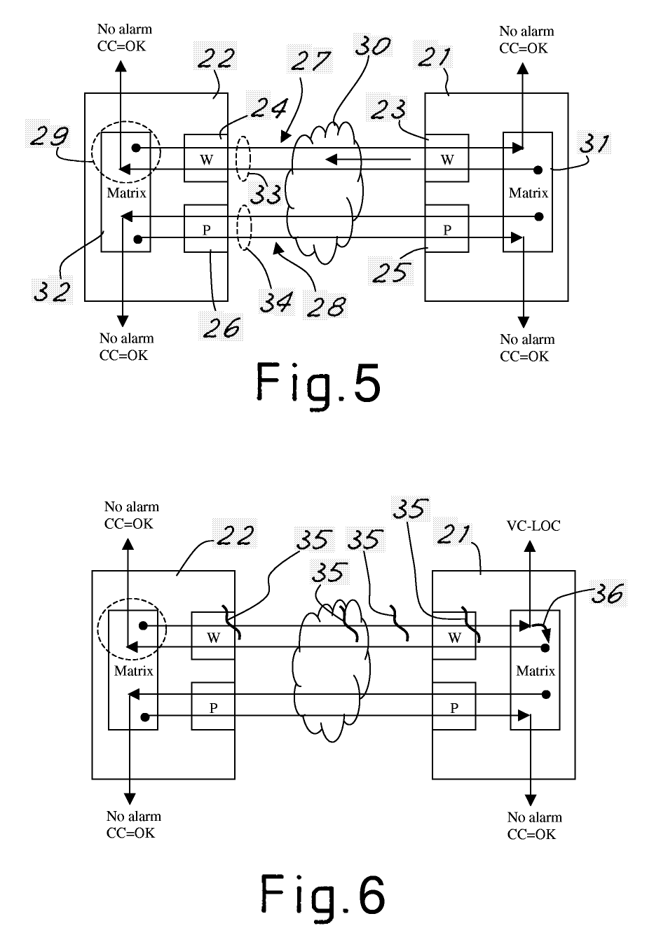

FIGS. 5 to 10 show consecutive steps of reactivation of traffic in case of one-way failure using the protection system of FIGS. 3 and 4, and shows switching from a working path to the corresponding protection path in applying the principles of this invention.

With reference to the figures, FIG. 1 shows a protection system 10 in which there is a primary node (PN) 11 and a secondary node (SN) 12 connected through an ATM transport network 30. It is assumed that the SN 12 has a local user 15 connected through the working path 16 to the PN 11. Reference number 17 designates the associated protection path. In a normal situation as shown in FIG. 1 the local traffic of the SN 12 travels on the path 16.

It should be noted that there is no constraint on the topology of said ATM transport network 30 and the only requirement is that it allows realization of the ATM connection between the PN 11 and the SN 12 over two independent paths 16, 17, that is to say, a single failure in the network can break one path (either 16 or 17) but not the both.

The continuity of the two paths is controlled by monitoring only two 2-way test circuits, to with, one for the working path 16 and the other for the protection path 17, termed Test Trails 19, 20 respectively. The Test Trails of the working path 16 and the protection path 17 are shown diagrammatically with broken line arrows designated respectively by reference numbers 19 and 20.

The test trails 19,20 are the appropriate ATM VPCs (Virtual Path Connection) or VCCs (Virtual Channel Connection) created purposely to allow said monitoring by applying standard methods (for example through the 2-way Continuity Check functionality in accordance with ITU-T I.610 recommendation, on both PN and SN, or loop back in accordance with the ITU-T I.610 recommendation). Test cells generated by the SN 12 are transmitted to the PN 11 and retransmitted back from PN 11 to SN 12, or for example SN 12 generates a standard Continuity Check—‘source’ Continuity Check function—and PN 11 realizes the ATM cross-connection of the VPC/VCC entering link of the Test Trail 19,20 from the SN 12 on the outgoing trail 19 or 20 towards the SN 12 (where the ‘sink’ Continuity Check function is performed).

As described in greater detail below, FIGS. 5 to 10 relate in particular to the case in which the SN 12 monitors its own Test Trails 19,20 (ATM VP/VC) through the 2-way Continuity Check functionality according to ITU-T I.610 but the substance of the invention would not change if the Test Trails were monitored in another manner.

As concerns the flow of traffic, the PN 11 in the direction towards the SN 12, always transmits the ATM cells of any circuit directed towards the SN 12 both on the working path 16 and the protection path 17 (multicast of the ATM cells). In the reverse direction, the PN 11 always performs channel merging of the ATM cells of the two VPC/VCC connections entering from the working path 16 and the protection path 17, where at any moment, only one of the two connections really carries the client's ATM cells while the other does not supply ATM cells, due to the mechanisms of the invention.

It is noted that the ATM merge function carried out by the PN 11 is not new but is a characteristic described in international standards (for example in ITU-T I.731) and is normally supplied by the ATM nodes. In any case, none of the prior known protection systems that conform to the I.630 recommendation use the merge function and, indeed, all of the prior known systems that comply with the I.630 recommendation always select only one of the two paths 16 or 17 from which to receive the traffic.

It is to be noted that the ITU G.808.1 contains the “merging” selector concept, however, this recommendation states (see paragraph 3.3.5.3.2) that merging works only in combination with switches in both working and protection inputs to the selector bridge, in order to prevent the AIS on the standby transport path being merged with the normal traffic signal selected from the active transport path. Therefore the active transport path 16 will have its switch closed, while the standby transport path 17 will have its switch opened.

This invention does not require the inclusion of such switches alternatively closed/open, but it is based on just the opposite mechanism, that is both working path 16 and protection path 17 are always merged, because AIS it is, a priori, supposed to be inhibited in the ring (exploiting the fact that this inhibition is acceptable in the ATM network of many Operators).

This idea, to keep AIS and RDI inhibited (ATM-AIS is inhibited in the PN 11 and in the interconnecting network 30, whilst ATM-RDI is inhibited in the SN 12), is a very distinctive point of the present invention.

In fact, there are other alternatives to avoid merging AIS/RDI, coming from the failed path (e.g. 16), with the good customer traffic 15, coming from the safe path (e.g. 17) but all these alternatives imply a burden of operations in the PN that this node cannot be able to perform. An example of such an unacceptable alternative would be to terminate the AIS and the RDI cells in the PN 11 before merging. Similarly it may be not cost effective to integrate such unacceptable operations in the PN 11.

In accordance with the principles of the invention, a failure that breaks one of the two paths 16 or 17, working or protection is detected by the SN 12 by monitoring of the Test Trails 19 and 20 and, for example, if the broken path is the working path 16, all the local traffic is switched to the other path 17.

The PN 11 does not perform any switching action on the traffic following a failure in the path 16 or 17.

FIG. 2 also shows diagrammatically the occurrence of a failure, for example at point 18, that is on the working path 16.

This breaks the Test Trails 19 on working path 16. The SN 12 detects this and switches onto the protection path 17. In the direction towards the SN 12 the protection mechanism in accordance with this invention can be seen to work similarly to that of a standard I.630/G.808.1 SNC/T 1+1 protection unit. The PN 11 acts as a bridge to each channel on both the working and protection paths (16, 17) and the SN 12 selects on which side (path 16 or 17) to receive the signal depending on the state of the associated Test Trail 19 or 20.

The difference between the present invention and prior known protection systems that comply with the recommendation I.630/G.808.1 resides in the alarms that the SN 12 allows for to cause the protection mechanism to trip.

In the prior known I.630/G.808.1 protection systems, only the alarms indicating failure of the direction of reception (for example, Alarm Indication Signal AIS) are taken into consideration, while in the solution in accordance with this invention, the Remote Defect Indication (RDI) can cause the protection switching to trip to protect against one-way failures from SN 12 to PN 11 also, as clarified below.

In the direction from SN 12 to PN 11, the SN 12 can be seen to work similarly to the prior known protection systems of recommendation I.630/G.808.1 SNC/T 1:1. That is to say, that it transmits on the working path 16 or the protection path 17 depending on the state of the path. In the case of the present invention there is also a difference from the I.630/G.808.1 SNC/T 1:1 mechanisms because, while with these known mechanism it is the APS protocol that indicates which path 16, 17 must be used, with the system in accordance with this invention, no use is made of APS protocol and only the alarms derived from monitoring of the Test Trails 19, 20 including the RDI, cause switching of path selection and this is an innovation compared with the known protection systems.

Another difference is that with the present invention the PN 11 does not perform any switching action following failure in the ring 30, whereas with the prior known systems that comply with the I.630/G.808.1 recommendations have identical behavior for the two protection end points (11, 12).

The ATM protection in accordance with this invention therefore uses standard characteristics (multicast connections, merging of ATM connections, test trail monitoring) but in an innovative manner that allows indubitable operating advantages with limited cost while avoiding the need for more sophisticated and costly characteristics as would be required using standard systems.

FIGS. 3 and 4 show, by way of example, a protection system of the invention similar to that of FIGS. 1 and 2, but with the nodes PN 11 and SN 12 connected in a ring network 30. In particular, in this case the PN 11 is also definable as Head Of Ring (HOR) and the nodes SN 12, 13, 14, are definable also as Other Ring Equipment (ORE).

In the FIGS. 3 and 4, in addition to the SN 12 of FIGS. 1 and 2, there are shown additional OREs (or SNs) 13 and 14 making up other nodes of the ring 30. Any ORE (12,13,14) proves the integrity of both the working path 16 and protection path 17 by monitoring its own Test Trails.

As in the example of FIGS. 1 and 2, the SN 12 has local user traffic 15 connected over the working path 16 to the PN 11. The respective protection path 17 is the rest of the ring 30 in the opposite direction. In a normal situation, the local traffic travels on path 16.

The Test Trails 19, 20 of the working path 16 and the protection path 17 are shown diagrammatically, again with the broken-line arrows of reference numbers 19 and 20.

In accordance with the principles of this invention the position of a failure in the ring 30 determines which OREs are involved in the failure; only the OREs 12, 13, 14 involved, detect the failure by monitoring their own Test Trails 19, 20 and consequently activate a switching procedure, while the other OREs (12,13,14) do not take any action (no action is taken by any ORE (12,13,14) on the ‘passing through’ connections). If a failure is detected, the ORE (12,13,14) that detects it automatically switches only the ATM interconnections of its local clients from the failed path 16 or 17 to the other path to restore the traffic.

The HOR (PN 11) does not perform any action following a failure in the ring. In the particular case of the following example, upon occurrence of the failure 18, the Test Trails 19 on the working path 16 are broken. The ORE 12 detects this, and switches traffic 15 onto the protection path 17. The other OREs 13 and 14 not involved in the failure do not take any switching action and let pass the connections from and to, the ORE 12, whose connections now pass onto the protection path 17.

FIGS. 5 to 10 show consecutive steps of a reactivation of traffic in case of one-way failure, with switching of the traffic 15 from a working path 16 to the corresponding protection path 17 by applying the principles of this invention in a generic network.

In particular, FIG. 5 shows diagrammatically the connection (when the network 30 is without failures) between a PN 21 and an SN 22, and applying the protection principles in accordance with this invention. In the example of FIGS. 5 to 10, the PNs and SNs have working ports (respectively 23 and 24) and protection ports (respectively 25 an 26) interconnected by working paths 27 and protection paths 28 over a generic transport network 30. The nodes 21 and 22 have within them respective known matrices 31, 32. In the situation of FIG. 5 the traffic 15 uses the path indicated generically by reference number 29.

The VCC Test Trails of the ATM system (indicated diagrammatically by 33 and 34 for the working and protection paths respectively) allow surveillance of the connections.

As shown diagrammatically in FIG. 5, when the network 30 is without failures, the status of the Test Trails is OK and the SN 22 uses the working path 33 for traffic.

FIGS. 6, 7 and 8 show the same components as shown in FIG. 5, during a sequence of operations that, due to a single one-way failure, that could happen, for example at any point among those indicated by reference number 35. The protection system in accordance with this invention uses basically standard signals of an ATM system, but in an innovative way.

In particular, FIG. 6 shows detection of the ATM Loss Of Continuity condition (LOC) of the PN 21 (that causes emission of a VC-LOC) signal and insertion (36) of an ATM Remote Defect Indication (VC-RDI) on the still active path.

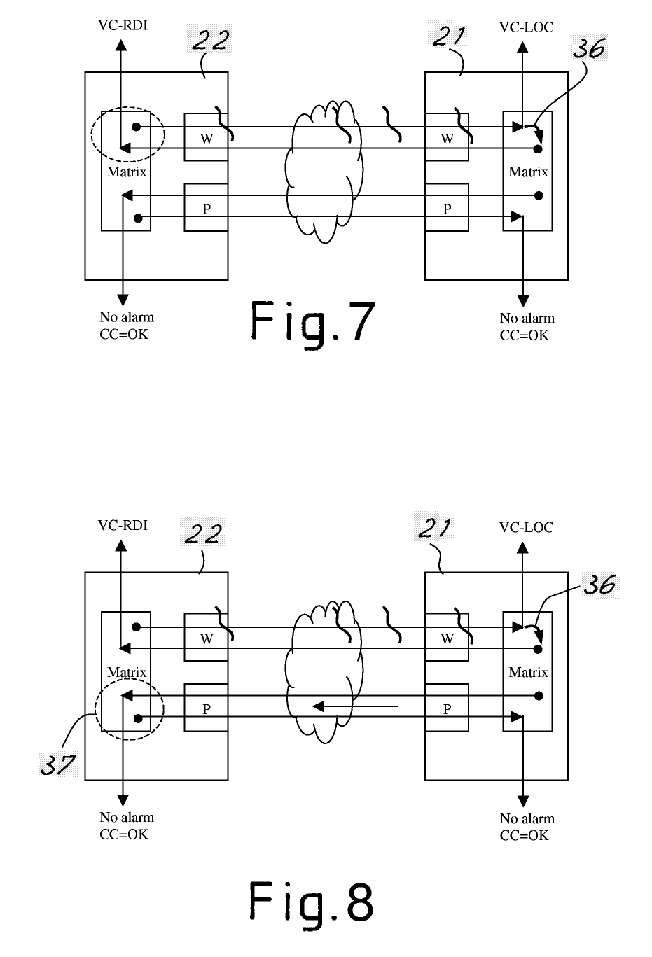

FIG. 7 shows the RDI detection in the SN 22 with emission of the VC-RDI alarm signal.

FIG. 8 shows the traffic switching that is done in the SN 22, which switches the local traffic onto the protection path (indicated by the numeral 37).

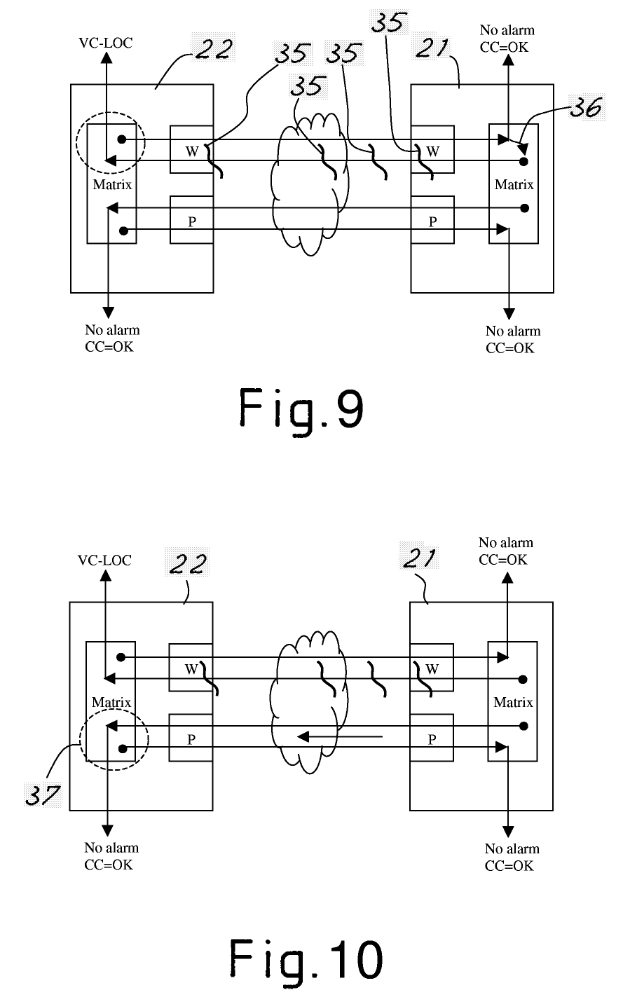

In the case illustrated in FIGS. 9 and 10 of one-way failure associated with the other working direction, the operation is still simpler; the SN 22 detects the VC-LOC condition upon reception of the Test Trail 33, following which, the SN 22 switches local traffic onto the protection path 37.

It is now clear that the preset purposes have been achieved using a protection system in accordance with this invention.

In addition to simplicity and ease of implementation, it must also be considered that in some types of application of this invention compared with the prior known I.630/G.808.1 or PNNI protection systems, ensures better performance in the time employed to restore traffic following a failure. For example, in a ring network 30, with centripetal traffic from peripheral nodes (SN) to a central node (PN), the present invention ensures an exchange time that does not increase with the increase in the number of nodes in the ring 30, contrary to the prior known I.630/G.808.1 and PNNI solutions. Therefore present invention offers a more scalable solution compared with prior known systems.

In the solution in accordance with this invention the standard function of insertion of AIS/RDI following defects, as defined in the I.610 Standard, must be inhibited (ATM-AIS shall be inhibited in the PN and in the interconnecting network, whilst ATM-RDI shall be inhibited in the SN). Otherwise in case of failure these cells would be brought together with the ATM cells of customers that arrive from the protection path and thus seriously disturb the customer's traffic. However, this inhibition is already operating in many networks (for example, access) for other reasons, hence in these cases the present invention is fully applicable.

Naturally the above description of an embodiment applying the innovative principles of this invention is given by way of non-limiting example of said principles within the scope of the exclusive right claimed here. In a further embodiment applying the principles of this invention, the primary and/or secondary node uses the system of this invention to protect only one part of the circuits of the local users connected thereto.

In a further embodiment of the present invention an individual physical ATM node can implement the protection system in accordance with this invention in an independent manner for multiple groups of its local users. This may be done, for example with an individual node that acts independently for each group either as the primary node or as a secondary node, so that each group of circuits is protected towards a different primary or secondary node in accordance with the present invention.

1-11. (canceled)

12. A protection system for an ATM network comprising:
a) a primary node and a secondary node interconnected via a bi-directional working path and a bi-directional protection path;
b) bi-directional test circuits for both the working path and the protection path for detecting loss of continuity in said working path and said protection path;
c) said primary node configured to:
1) transmit and receive ATM traffic on the working path and the protection path;
2) merge ATM traffic on the working path and the protection path without switching;
3) inhibit a forward alarm signal when continuity is lost on a transmit link of the working path or the protection path;
d) said secondary node configured to:
1) switch ATM traffic between the working path and the protection path upon detection of a discontinuity;
2) inhibit a return alarm signal when continuity is lost on a receive link of the working path or the protection path.

13. A protection system in accordance with claim 12 wherein said secondary node detects loss of continuity by transmitting continuity check cells toward the primary node on the test circuit and receiving looped back check cells from the primary node.

14. A protection system in accordance with claim 12 wherein the secondary node detects loss of continuity by detecting a remote fault indication transmitted from the primary node to the secondary node.

15. A protection system in accordance with claim 12 wherein the primary and secondary nodes are connected in a ring network.

16. A protection system in accordance with claim 12 wherein an ATM physical node implements the protection system independently for multiple groups of its local users while being able to function for each group indifferently as a primary node or secondary node and each group of circuits being protected against a different primary or secondary node.

17. An ATM system incorporating the protection system in accordance with claim 12.

18. A method of protecting ATM network having a primary node and a secondary node interconnected via a bi-directional working path and a bi-directional protection path, the method comprising:
a) monitoring the working path and the protection path through the use of bi-directional test circuits;
a) transmitting and receiving at the ATM traffic on both the working path and the protection path at the primary node;
b) merging the ATM traffic received over the working path and the protection path without switching;
c) inhibiting a forward alarm signal at the primary node when loss of continuity is detected on a transmit link of the working path or the protection path;
d) switching ATM traffic between the working path and the protection path upon detection of loss of continuity at the secondary node; and
e) inhibiting a return alarm signal at the secondary node when discontinuity is detected on a receive link of the working path or the protection path.

19. A method according to claim 18 further comprising detecting loss of continuity at the secondary node by transmitting continuity check cells toward the primary node on the test circuit and receiving looped back check cells from the primary node.

20. The method of claim 18 further comprising detecting loss of continuity by detecting a remote fault indication transmitted from the primary node to the secondary node.
